(19) United States
(12) Patent Application Publication
(10) Pub. No.: US 2008/0244007 A1
(43) Pub. Date: Oct. 2, 2008

(54) ELECTRONIC CONFERENCE SYSTEM, INFORMATION PROCESSING APPARATUS, AND PROGRAM

(75) Inventor: Michiaki Eri, Hino-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/047,096

(22) Filed: Mar. 12, 2008

(30) Foreign Application Priority Data
Mar. 29, 2007 (JP) 2007-087198

(51) Int. Cl. G06F 15/16

(52) U.S. Cl. 709/205

(57) ABSTRACT

According to one embodiment, a client computer of an electronic conference system comprises a unit which determines whether or not the client computer is equipped with the image pickup device, a unit which notifying a server computer of the electronic conference system of the determination, a unit which receives the member list information from the server computer, and a unit which displays the plurality of client computers in list form so as to make it possible to determine whether or not each of the client computers is equipped with the image pickup device, based on the member list information.

### CROSS-REFERENCE TO RELATED APPLICATIONS

This application is based upon and claims the benefit of priority from Japanese Patent Application No. 2007-087198, filed Mar. 29, 2007, the entire contents of which are incorporated herein by reference.

### BACKGROUND

1. Field

One embodiment of the invention relates to a control technique suitably applied to an electronic conference system utilizing a computer network.

2. Description of the Related Art

In recent years, with data communication environments established as social infrastructures, electronic conference systems have started to prevail in which a plurality of remotely scattered users can exchange their opinions via a computer network. Various proposals have been made to smoothly conduct an electronic conference (see, for example, Jpn. Pat. Appln. KOKAI Publication No. 6-274596).

In an electronic conference system, for example, a computer used by each user is equipped with a headset having a microphone and a headphone integrated together, and a camera. Sound collected through the microphone and motion pictures taken with the camera are transmitted between the computers to allow all the participants of the conference to discuss common subjects.

In the most common example, the electronic conference system is constructed using a client server system scheme in which the computer used by each user is positioned as a client computer and in which a server computer managing data transmission between the client computers is installed. The server computer manages the data transmission between the client computers using either of the following two methods.

In the first method, the server computer always intervenes in the data transmission between the client computers. Each client computer transmits data to the server computer and receives data from the server computer. For example, when three users, A, B, and C, hold a conference, the server computer performs control such that data transmitted by the user A is transferred to the users B and C. With this scheme, the server computer can not only transfer each user's data in a time-sharing manner but also synthesize plural users' data for transfer.

In the second method, the server computer does not intervene in the data transmission between the client computers. Each client computer transmits and receives data to and from the client computers of the other participants. For example, if the three users, A, B, and C, hold a conference, the server computer instructs the user A to transmit and receive data to and from the users B and C. The server computer gives a similar instruction to the users B and C.

For audio data, only a relatively low processing capability is required for transmission and reception. Thus, even if the server computer always intervenes in the transfer, the server computer is not subjected to heavy loads. Consequently, the first method is often adopted. For motion picture data, a relatively high processing capability is required for transmission and reception. Thus, if the server computer always intervenes in the transfer, the server computer is subjected to heavy loads. Consequently, if costs are taken into account, the second method is often adopted.

Now, it is assumed that the server computer uses the second method for management to allow the client computers to transmit and receive motion picture data to and from one another. In this case, each client computer transmits and receives motion picture data to and from the client computers of the other participants. Thus, an upper limit is normally set for the number of clients allowed to transmit and receive motion picture data taking into account the processing capability of each client computer and the communication speed of the computer network. Consequently, when for example, eight users hold a conference, three users can move discussions along while viewing motion pictures, whereas the remaining five users can only aurally participate in the discussion.

As described above, with the second method, the server computer gives each of the users participating in the conference an instruction indicating to and from which of the other users that user is to transmit and receive motion picture data. The serve computer continues giving the instruction to the client computers until the upper limit of the number of users participating in the conference is reached. That is, the process is executed on what is called a first-come-first-served basis; users who participate in the conference earlier are forcibly endowed with the right to transmit and receive motion picture data.

Furthermore, it is possible to intentionally participate in the conference only aurally. Thus, if a user with this intention participates in the conference earlier with a computer equipped only with a headset and not with a camera, the computer that cannot take or transmit motion pictures (though the computer can display motion pictures from the other participants) is endowed with the right to transmit and receive motion picture data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a configuration of an electronic conference system in accordance with an embodiment of the present invention;

FIG. 2 is an exemplary first diagram illustrating a procedure of holding a conference with the electronic conference system in accordance with the embodiment;

FIG. 3 is an exemplary second diagram illustrating the procedure of holding a conference with the electronic conference system in accordance with the embodiment;

FIG. 4 is an exemplary diagram showing how conference members' audio data is transmitted and received in the electronic conference system in accordance with the embodiment;

FIG. 5 is an exemplary diagram illustrating a procedure of starting transmission and reception of image data in the electronic conference system in accordance with the embodiment;

FIG. 6 is an exemplary diagram showing how the conference members' image data is transmitted and received in the electronic conference system in accordance with the embodiment;

FIG. 7 is an exemplary diagram showing functional blocks of a video server applied to the electronic conference system in accordance with the embodiment;

FIG. 8 is an exemplary table showing a conference management table held by the video server in accordance with the embodiment;

FIG. 9 is an exemplary diagram showing functional blocks of a client computer applied to the electronic conference system in accordance with the embodiment;

FIG. 10 is an exemplary table showing a conference status management table held by the video server in accordance with the embodiment;

FIG. 11 is an exemplary diagram showing a first screen presented to a user by the client computer in accordance with the embodiment;

FIG. 12 is an exemplary diagram showing a second screen presented to the user by the client computer in accordance with the embodiment;

FIG. 13 is an exemplary flowchart showing a first operational procedure executed by the client computer in the electronic conference system in accordance with the embodiment;

FIG. 14 is an exemplary flowchart showing a first operational procedure executed by the video server in the electronic conference system in accordance with the embodiment;

FIG. 15 is an exemplary flowchart showing a second operational procedure executed by the client computer in the electronic conference system in accordance with the embodiment; and

FIG. 16 is an exemplary flowchart showing a second operational procedure executed by the video server in the electronic conference system in accordance with the embodiment.

### DETAILED DESCRIPTION

Various embodiments according to the invention will be described hereinafter with reference to the accompanying drawings. In general, according to one embodiment of the invention, an electronic conference system in which a plurality of client computers connected to the same server computer via a network transmit and receive image data to and from one another without intervention of the server computer, the server computer comprises a member information receiving unit configured to receive, from each of the plurality of client computers, a notification indicating whether or not the client computer is equipped with an image pickup device, and a member list information transmitting unit configured to transmit, to the plurality of client computers, member list information which contains information regarding the plurality of client computers, the information including information on the presence or absence of the image pickup device received by the member information receiving unit, the client computer comprises a determining unit configured to determine whether or not the client computer is equipped with the image pickup device, a member information notifying unit configured to notifying the server computer of the determination made by the determining unit, a member list information receiving unit configured to receive the member list information from the server computer, and a member information list display unit configured to display the plurality of client computers in list form so as to make it possible to determine whether or not each of the client computers is equipped with the image pickup device, based on the member list information received from the member list information receiving unit.

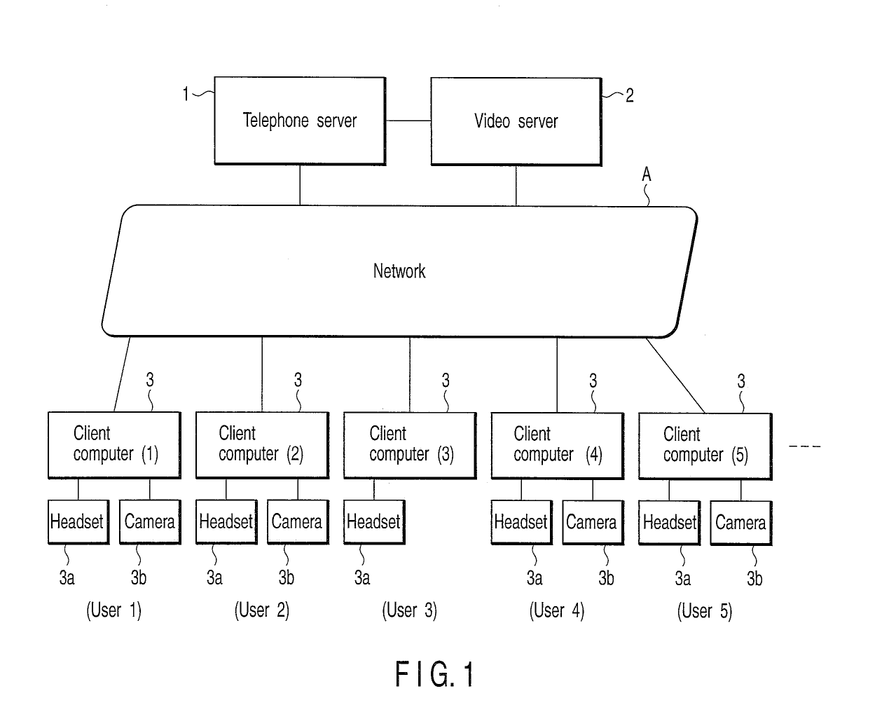

FIG. 1 is an exemplary diagram showing a configuration of an electronic conference system in accordance with the present embodiment. As shown in FIG. 1, the electronic conference system is composed of two server computers, a telephone server 1 and a video server 2, and a large number of client computers 3 are connected together via a network A, for example, the Internet or a LAN (Local Area Network).

The client computer 3 is equipped with a headset 3a having a microphone for aural input and a headphone for aural output which are integrated together. Each user (member) participating in a conference places a headset 3a on his or her head to express an opinion through the microphone and listen to the others' opinions through the headphone. The client computer 3 can further be equipped with a camera 3b to allow the user to transmit the user's image to the other users. Even if the computer 3 is not equipped with a camera 3b, the user can view images of all the other participants. Here, it is assumed that users 1, 2, 4, and 5 use a camera, whereas a user 3 does not use a camera.

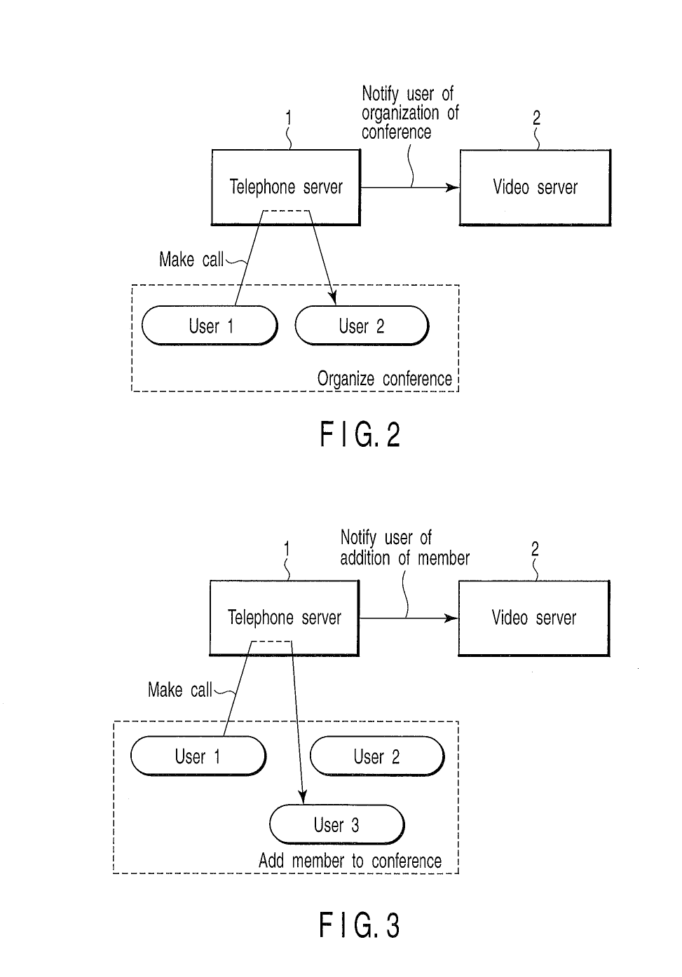

First, description will be given of a procedure of conducting a conference with the electronic conference system, with reference to FIGS. 2 and 3.

As shown in FIG. 2, when the user 1 sends a request to the telephone server 1 to enable a telephone call to the user 2 (the user 1 calls the user 2), a conference having the users 1 and 2 as members is organized. The telephone server 1 notifies the video server 2 that the conference has been organized and of the members of the conference. Furthermore, for example, when the user 1 puts the call to the user 2 on hold and starts to call the user 3, the user 3 is added to the conference as a conference member, as shown in FIG. 3. This also applies to the case in which the user starts to call the user 3. The telephone server 1 also notifies the video server 2 of the addition of the member. To withdraw from the conference, the user may disconnect the call. The telephone server 1 also notifies the video server 2 of the disconnection.

The electronic conference system also allows a plurality of conferences to be simultaneously held. That is, in parallel with a conference having the users 1, 2, and 3 as members, a conference having the users 4 and 5 as members is simultaneously held.

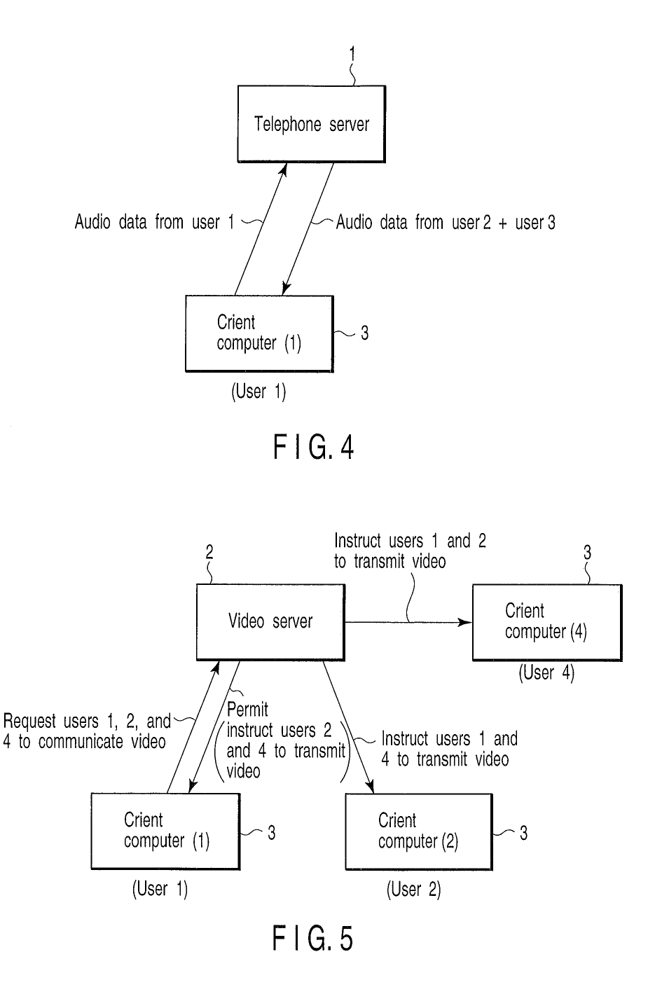

When the conference having the users 1, 2, and 3 as members is held, the telephone server 1 receives and transfers audio data transmitted by any of the members to the other members. More specifically, the telephone server 1 subjects audio data transmitted by the users 1 and 2 to a time division or synthesis process and transfers the resulting data to the user 3. The telephone server 1 subjects audio data transmitted by the users 1 and 3 to the time division or synthesis process and transfers the resulting data to the user 2. The telephone server 1 subjects audio data transmitted by the users 2 and 3 to the time division or synthesis process and transfers the resulting data to the user 1. Thus, for audio data, as shown in FIG. 4, the client computer 3 used by each user performs transmission to and from the telephone server 1 on a one-to-one basis. In other words, the telephone server 1 always intervenes in the transmission of audio data between the client computers 3.

On the other hand, for transfer of image data, unlike transfer of audio data, the video server 2 does not intervene in the transmission of image data between the client computers 3, due to the heavy loads associated with transfer of image data. In the following, it is assumed that the video server 2 recognizes, through a notification from the telephone server 1, that a conference having the five users 1 to 5 as members is being conducted. In conjunction with a call exchanged through the telephone server 1, the video server 2 automatically causes the client computers to start transmission of image data on a first-come-first-served basis; the client computer that first reaches the video server 2 is first allowed to perform transmission. The video server 2 subsequently receives a request from any of the users 1 to 5 indicating that the user desires to transmit and receive image data to and from any other user.

For example, upon receiving a request from the user 1 indicating that the user 1 desires to transmit and receive image data to and from the users 2 and 4, the video server 2 instructs the client computer (1) 3 of the user 1 to transmit image data to the users 2 and 4, instructs the client computer (2) 3 of the user 2 to transmit image data to the users 1 and 4, instructs the client computer (4) 3 of the user 4 to transmit image data to the users 1 and 2 as shown in FIG. 5.

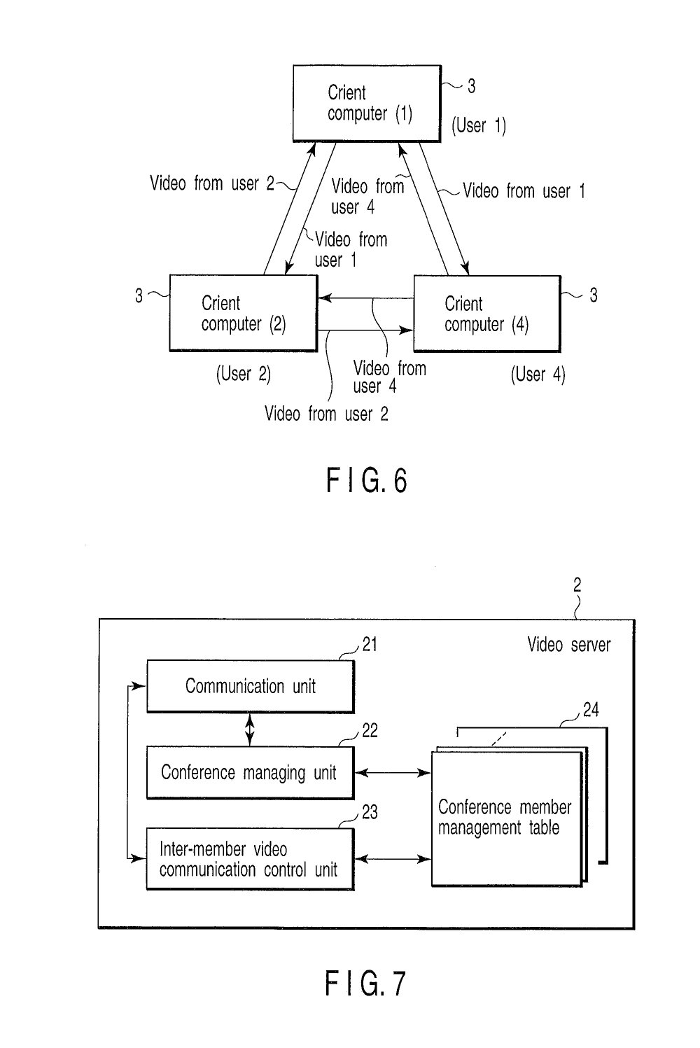

As a result, for image data, the client computer 3 used by each user performs transmission to and from the other appropriate users on a one-to-many basis as shown in FIG. 6. Thus, an upper limit is normally set for the number of users that can transmit and receive image data taking into account the processing capability of the client computer 3 and the communication speed of the network A. The electronic conference system is adapted to efficiently support administration of electronic conferences by performing control as to which of the users are allowed to transmit and receive image data to and from one another. This will be described below in detail.

FIG. 7 is an exemplary diagram showing functional blocks of the video server 2.

As shown in FIG. 7, the video server 2 has a processing section, which includes a communication unit 21, a conference managing unit 22 and an inter-member video communication control unit 23, and a data section, which includes a conference member management table 24. The processing section is composed of programs loaded from a dedicated integrated circuit or an external storage device into a main memory and executed by the CPU. The data section is provided on a virtual storage device composed of the main memory and the external storage device.

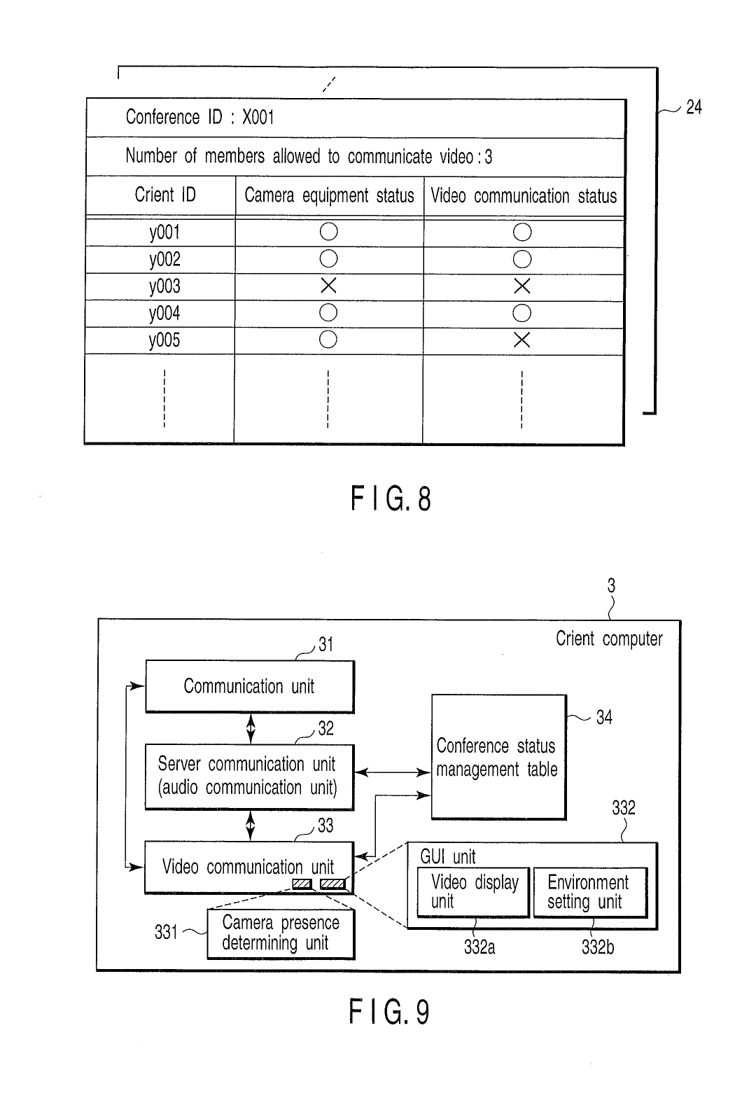

The communication unit 21 performs communications with the telephone server 1 and communications with the client computers 3 via the network A. On the basis of a notification from the telephone sever 1 indicating a requested conference, an increase or decrease in the number of members, or the like, the conference managing unit 22 stores information on each conference and each member constituting the conference, in the conference member management table 24. The conference managing unit 22 also stores information on the presence or absence of a camera 3b provided by each of the client computers 3, in the conference member management table 24. FIG. 8 is a table showing an example of the conference member management table 24.

The telephone server 1 provides a conference ID every time a conference is organized and communicates a value for the conference ID to the conference managing unit 22. The conference managing unit 22 stores the communicated conference ID in the conference member management table 24.

The conference managing unit 22 further determines the number of client computers that can transmit and receive image data on the basis of the type of the network (in this case, the network A) to which the constituent members of the conference are connected. The conference managing unit 22 stores the value of the number in the conference member management table 24. More specifically, the conference managing unit 22 determines a larger value for a network with a higher communication speed.

For example, it is assumed that the telephone server 1 and the video server 2 are also connected to a network B of a type different from that of the network A and that a conference is organized by the group of client computers connected to the network B. The conference managing unit 22 may determine a value different from that for the conference organized on the network A.

In this case, as shown in FIG. 8, it is assumed that image data can be transmitted between three client computers (the number of members with whom a particular user can make video communications). The number of members with whom a particular user can make video communications may be set at a fixed value as a specification for the system regardless of the type of the network. Alternatively, the number may be determined on the basis of the performance of the client computer 3, the performance of the network A, an administrator's settings, or the like.

The conference member management table 24 further stores identifiers (client IDs) for the constituent members of each conference, the presence or absence of a camera 3b in the client computer 3 used by each of the constituent members (camera equipment status), and information indicating whether or not the client computer is transmitting and receiving image data (video communication status). Information in a video communication status field is updated and managed by the inter-member video communication control unit 23. Upon receiving a request from any of the client computers 3 indicating that the client computer 3 desires to transmit and receive image data to and from any other client computer 3, the inter-member video communication control unit 23 transmits an instruction to the client computer 3 performing transmission and reception of the image data as indicated in the video communication status field, to command the client computer 3 to stop the transmission and reception. The inter-member video communication control unit 23 further transmits an instruction to the client computer 3 having transmitted the new request, together with image data destination information, to command the client computer 3 to start transmitting and receiving image data. In this case, the inter-member video communication control unit 23 also updates the information in the video information status field.

The conference managing unit 22 also has a function of providing the client computer 3 with information (member list information) in the conference member management table 24 relating to the conference to which the client computer 3 belongs.

FIG. 9 shows the functional blocks of the client computer 3.

As shown in FIG. 9, the client computer 3 has a processing section including a communication unit 31, a server communication unit 32, and a video communication unit 33, and a data section including a conference status management table 34.

The communication unit 31 performs communications with the telephone server 1, video server 2, and any other client computer 3 via the network A. The server communication unit 32 starts a call to any other client computer 3 and controls communications to and from the telephone server 1 in order to hold the conference. That is, the server communication unit 32 also has a function of an audio communication unit that transmits and receives audio data to and from the telephone server 1. Second, the server communication unit 32 controls communications to and from the video server 2 in order to transmit and receive image data to and from any other client computer 3. More specifically, the server communication unit 32 sends the presence or absence of a camera in the client computer 3 to the video server 2. The server communication unit 32 also requests the video server 2 to provide the client computer 3 with information in the conference member management table 24 relating to the conference to which the client computer 3 belongs, and stores the information returned in response to the request, in the conference status management table 34. The server communication unit 32 further transmits a request to the video server 2 indicating that the client computer 3 desires to transmit and receive image data to and from any other client computer 3.

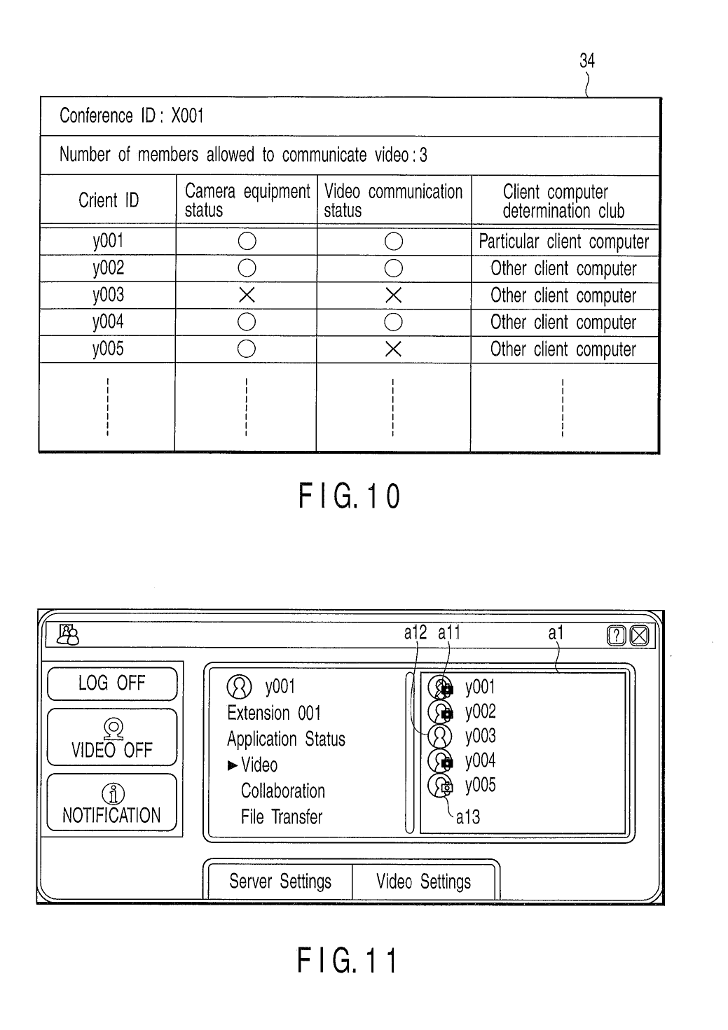

FIG. 10 is a table showing an example of the conference status management table 34, updated and managed by the server communication unit 32. As shown in FIG. 10, the conference status management table 34 stores information on the conference to which the client computer 3 belongs; the information is managed by the conference member management table 24 of the video server 2. The conference status management table 34 also manages a determination flag that helps to determine whether each client ID indicates a particular client computer or any other client computer.

The video communication unit 33 executes various processes required to transmit and receive image data to and from any other client computer 3. The video communication unit 33 has a camera presence determining unit 331 and a GUI unit 332. The camera presence determining unit 331 of each client computer 3 determines whether or not that client computer 3 is equipped with a camera 3b. The server communication unit 32 periodically sends the determination made by the camera presence determining unit 331 of the video communication unit 33 to the video server 2. With a change in the status of the presence of a camera, the video server 2 notifies each client of the changed status. At this time, the server communication unit 32 also reflects the content of the notification in the conference status management table 34.

The GUI unit 332 has a video display unit 332a that displays image data transmitted by any other client computer 3 and an environment setting unit 332b that sets environments for the transmission and reception of image data for the conference. FIG. 11 shows an example of a first screen presented to the user by the environment setting unit 332b.

When an operation for displaying this screen is performed, the environment setting unit 332b requests the sever communication unit 32 to update the conference status management table 34. In response to the request, the server communication unit 32 of each client computer 3 updates the conference status management table 34 by acquiring information on the conference to which that client computer 3 belongs, from the video server 2; the information is managed by the conference member management table 24. The environment setting unit 332b uses the updated conference status management table 34 to display a screen shown in FIG. 11.

As shown in FIG. 11, the screen has a window al that lists the members of the conference. In listing the members in the window a1, the environment setting unit 332b adds, to the window, objects indicating (1) whether the ID indicates a particular client computer or any other computer, (2) whether or not the client computer is equipped with a camera, and whether or not the client computer is transmitting and receiving image data. Here, whether or not the ID indicates a particular client computer or any other computer is represented by the shading of person-like images (an object all represents the particular client computer, whereas the other objects represent the other client computers). Whether or not the client computer is equipped with a camera is represented by the presence or absence of a camera-like image (the object all represents the presence of the camera, whereas an object a12 represents the absence of a camera). Whether or not the client computer is transmitting and receiving image data is represented by the shading of the camera-like images (the object all shows that image data is being transmitted and received, whereas an object a13 shows that image data is not being transmitted or received).

That is, with reference to this screen, the users of the client computers 3 can determine that the five users 1 to 5 are in the conference and that the client computer 3 used by the user 3 is not equipped with a camera 3b and that image data is being transmitted between the users 1 and 2 and 4.

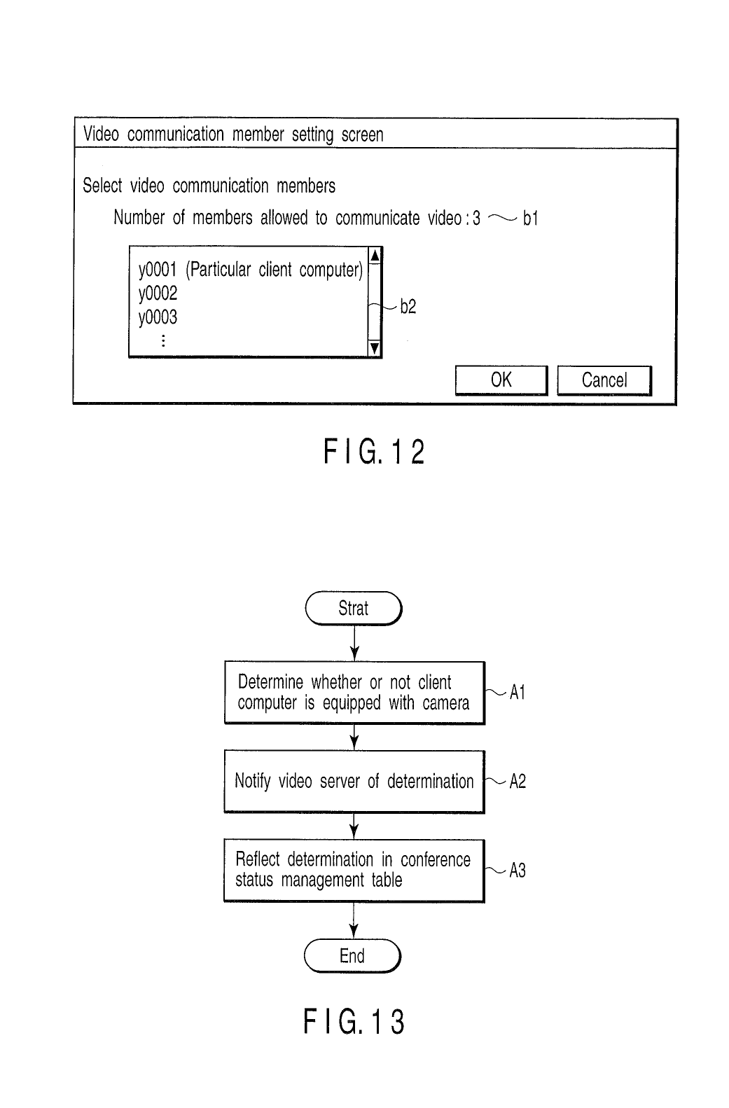

FIG. 12 shows an example of a second screen presented to the user by the environment setting unit 332b. The screen shows an area b1 showing the number of members with whom the user can make video communications and a window b2 that lists the members of the conference. The user can select, from the users displayed in the window b2, those to and from whom the user desires to transmit and receive image data, taking into account the upper limit on the number of members with whom the user can make video communications; the upper limit is shown by the area b1. The server communication unit 32 sends the selection to the video server 2. As a result, the inter-member video communication control unit 23 of the video server 2 transmits the above-described various notifications to the previously and newly selected client computers 3.

That is, the electronic conference system presents the first screen to allow the user to determine, when making selections on the second screen, whether or not each member has a camera and the current image data transmission status of each member. The electronic conference system thus efficiently supports administration of electronic conferences involving transmission and reception of image data. Furthermore, the electronic conference system presents the second screen to make it possible to optionally determine which of the members are to be endowed with the right to transmit and receive image data. The electronic conference system can thus efficiently support administration of electronic conferences involving transmission and reception of image data.

FIG. 13 is an exemplary flowchart showing a first operational procedure executed by the client computer 3 in the electronic conference system.

The camera presence determining unit 331 of the video communication unit 33 of each client computer 3 periodically determines whether or not that client computer 3 is equipped with a camera 3b (block A1). The server communication unit 32 notifies the video server 2 of the determination made by the camera presence determining unit 331 of the video communication unit 33 (block A2). The camera presence determining unit 331 subsequently receives a conference information notification from the video server and reflects the notification in the conference status management table 34 (block A3).

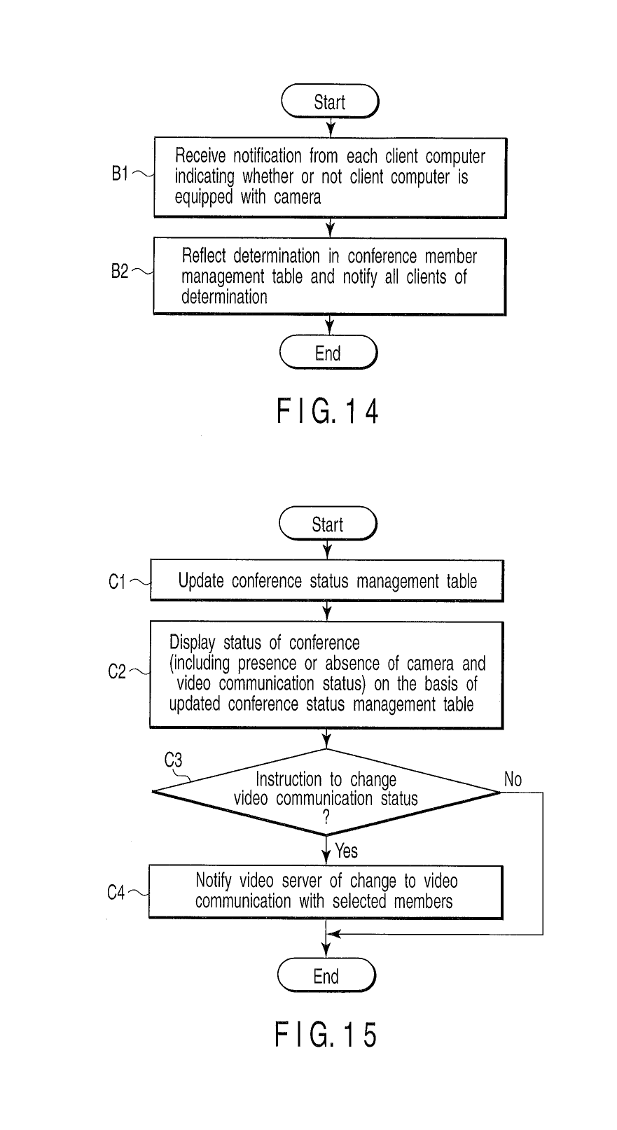

On the other hand, FIG. 14 is an exemplary flowchart showing a first operational procedure of the video server 2 in the electronic conference system.

The conference managing unit 22 receives the notification of the determination of whether or not the client computer is equipped with a camera 3b, from the client computer 3 (block B1). The conference managing unit 22 reflects the determination in the conference member management table 24 and notifies all the other clients of the determination (block B2).

FIG. 15 is an exemplary flowchart showing a second operational procedure of the client computer 3 in the electronic conference system.

The GUI unit 332 (environment setting unit 332b) of the video communication unit first updates the conference status management table 34 via the server communication unit 32 (block C1). Then, on the basis of the updated conference status management table 34, the GUI unit 332 displays the administrative status of the conference, including the presence or absence of a camera 3b and the image data transmission and reception status, in the form of a list of the members (block C2).

The GUI unit 332 also receives the instruction to change the image data transmission and reception status (YES in block C3). The GUI unit 332 then transmits a notification indicating that image data is to be transmitted between selected members, to the video server 2 via the server communication unit 32 (block C4).

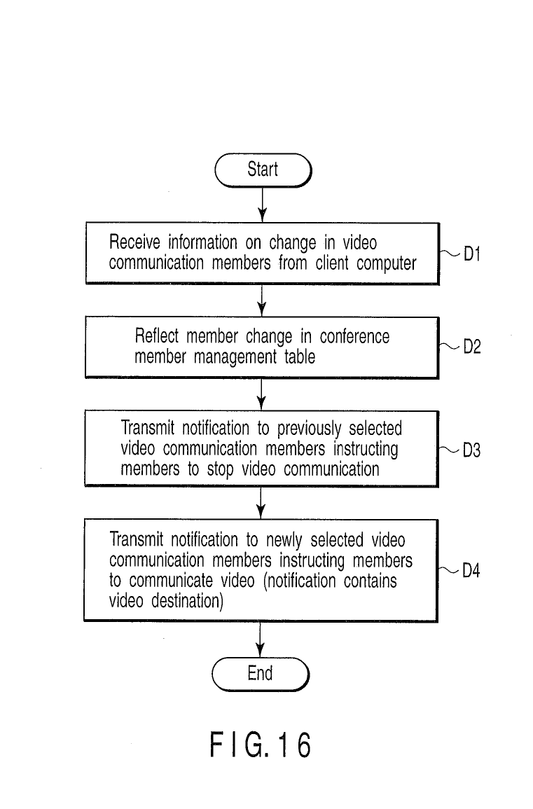

On the other hand, FIG. 16 is an exemplary flowchart showing a second operational procedure of the video server 2 in the electronic conference system.

The inter-member video communication control unit 23 receives information on a change in the members involved in the transmission and reception of image data, from the client computer 3 (block D1). The inter-member video communication control unit 23 first reflects the content of the change in the conference member management table 24 (block D2).

Then, the inter-member video communication control unit 23 notifies the client computers 3 now involved in the transmission and reception of image data that the transmission and reception are to be stopped (block D3). The inter-member video communication control unit 23 notifies newly selected client computers 3 that the transmission and reception of image data to and from these client computers 3 are to be started (block D4).

As described above, the electronic conference system makes it possible to efficiently support administration of electronic conferences involving the transmission and reception of image data.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic conference system in which a plurality of client computers connected to the same server computer via a network transmit and receive image data to and from one another without intervention of the server computer,
the server computer comprising:
a member information receiving unit configured to receive, from each of the plurality of client computers, a notification indicating whether or not the client computer is equipped with an image pickup device; and
a member list information transmitting unit configured to transmit, to the plurality of client computers, member list information which contains information regarding the plurality of client computers, the information including information on the presence or absence of the image pickup device received by the member information receiving unit,
the client computer comprising:
a determining unit configured to determine whether or not the client computer is equipped with the image pickup device;
a member information notifying unit configured to notifying the server computer of the determination made by the determining unit;
a member list information receiving unit configured to receive the member list information from the server computer; and
a member information list display unit configured to display the plurality of client computers in list form so as to make it possible to determine whether or not each of the client computers is equipped with the image pickup device, based on the member list information received from the member list information receiving unit.

2. The electronic conference system according to claim 1, wherein:
the member list information transmitting unit of the server computer places information indicating whether or not the client computer is transmitting and receiving image data, in the information on the plurality of client computers contained in the member list information, and
the member information list display unit of the client computer displays the plurality of client computers in list form so as to make it possible to determine whether or not each of the client computers is transmitting and receiving image data.

3. The electronic conference system according to claim 1, wherein:
the server computer further comprises a video member count determining unit configured to determine the number of client computers allowed to transmit and receive image data to and from one another, based on the type of the network connecting the plurality of client computers together,
the member list information transmitting unit of the server computer places information indicating the number of client computers determined by the video member count determining unit, in the member list information, and
the client computer further comprises a video member setting unit configured to allow selection of client computers to be involved in transmission and reception of image data, from the plurality of client computers contained in the member list information, taking into account an upper limit on the number of client computers contained in the member list information, and transmitting, to the server computer, a notification requesting the server computer to allow the selected client computers to transmit and receive image data to and from one another.

4. The electronic conference system according to claim 3, wherein the server computer further comprises a video member managing unit configured to transmit, upon newly receiving a notification requesting the server computer to allow a second client computer group different from a first client computer group now involved in transmission and reception of image data to transmit and receive image data, a notification instructing the first client computer group to stop the transmission and reception of the image data and transmitting, to each second client computer, a notification instructing the second client computer group to transmit and receive the image data, together with information identifying the client computers between which the image data is transmitted;

5. An information processing apparatus which transmits and receives image data to and from a plurality of other client computers connected to the same server computer via a network without intervention of the server computer, the apparatus comprising:
a determining unit configured to determine whether or not the information processing apparatus is equipped with an image pickup device;
a member information notifying unit configured to notify the server computer of the determination made by the determining unit;
a member list information receiving unit configured to receiving, from the server computer member, member list information which contains information regarding all the information processing apparatuses connected to the server computer via the network, the information including information on the presence or absence of the image pickup device; and
a member information list display unit configured to display all the information processing apparatuses in list form so as to make it possible to determine whether or not each of the information processing apparatuses is equipped with the image pickup device, based on the member list information received from the member list information receiving unit.

6. The information processing apparatus according to claim 5, wherein:
the information on all the client computers contained in the member list information contains information indicating whether or not the information processing apparatus is transmitting and receiving image data, and
the member information list display unit displays all the information processing apparatuses in list form so as to make it possible to determine whether or not each of the information processing apparatus is transmitting and receiving image data.

7. The information processing apparatus according to claim 5, wherein:
the member list information contains the number of information processing apparatuses allowed to transmit and receive image data to and from one another, and
the information processing apparatus further comprises a video member setting unit configured to allow selection of information processing apparatuses to be involved in transmission and reception of image data, from all the information processing apparatuses contained in the member list information, taking into account an upper limit on the number of information processing apparatuses contained in the member list information, and transmitting, to the server computer, a notification requesting the server computer to allow the selected information processing apparatuses to transmit and receive image data to and from one another.

8. A program allowing an information processing apparatus which transmits and receives image data to and from a plurality of other client computers connected to the same server computer via a network without intervention of the server computer, to function as:
a determining unit configured to determine whether or not the information processing apparatus is equipped with an image pickup device;
a member information notifying unit configured to notify the server computer of the determination made by the determining unit;
a member list information receiving unit configured to receive, from the server computer member, member list information which contains information regarding all the information processing apparatuses connected to the server computer via the network, the information including information on the presence or absence of the image pickup device; and
a member information list display unit configured to display all the information processing apparatuses in list form so as to make it possible to determine whether or not each of the information processing apparatuses is equipped with the image pickup device, based on the member list information received from the member list information receiving unit.

9. The program according to claim 8, wherein:
the information on all the client computers contained in the member list information contains information indicating whether or not the information processing apparatus is transmitting and receiving image data, and
the member information list display unit displays all the information processing apparatuses in list form so as to make it possible to determine whether or not each of the information processing apparatus is transmitting and receiving image data.

10. The program according to claim 8, wherein:
the member list information contains the number of information processing apparatuses allowed to transmit and receive image data to and from one another, and the program further allows the information processing apparatus to function as a video member setting unit configured to allow selection of information processing apparatuses to be involved in transmission and reception of image data, from all the information processing apparatuses contained in the member list information, taking into account an upper limit on the number of information processing apparatuses contained in the member list information, and transmitting, to the server computer, a notification requesting the server computer to allow the selected information processing apparatuses to transmit and receive image data to and from one another.
